(19) United States
(12) Patent Application Publication
(10) Pub. No.: US 2006/0080377 A1
(43) Pub. Date: Apr. 13, 2006

(54) Galois field multiplier and multiplication method thereof

(76) Inventor: Hung-Ming Chien, Hsinchu City (TW)

Correspondence Address: J C PATENTS, INC., 4 VENTURE, SUITE 250, IRVINE, CA, 92618, US

(21) Appl. No.: 11/049,760

(22) Filed: Feb. 2, 2005

(30) Foreign Application Priority Data
Oct. 13, 2004 (TW) 93130962

(51) Int. Cl. G06F 7/00

(52) U.S. Cl. 708/492

(57) ABSTRACT

A Galois field multiplier is provided. The Galois field multiplier comprises a lookup table device and an operation circuit. Wherein, the lookup table device obtains a coefficient matrix W by looking up a multiplicator coefficient table based on a multiplicator S. The operation circuit is coupled to the lookup table device for receiving a multiplicand A and the coefficient matrix W to calculate a product of multiplication R. The multiplicator S, the multiplicand A, and the product of multiplication R all belong to a Galois field (GF, 2^{m}). In the present invention, a coefficient matrix W is provided to the operation circuit by looking up the multiplicator coefficient table based on the multiplicator S. Accordingly, the present invention can simplify the operation circuit and reduce the calculating time by looking up the lookup table. Moreover, a multiplication method applied in the Galois field is also provided.

### CROSS-REFERENCE TO RELATED APPLICATION

This application claims the priority benefit of Taiwan application serial no. 93130962, filed on Oct. 13, 2004.

### BACKGROUND OF THE INVENTION

1. Field of the Invention

The present invention relates to a multiplier and a multiplication method thereof, and more particularly, to a Galois field multiplier and a multiplication method thereof.

2. Description of the Related Art

Along with continuous progress of semiconductor technology in electronic industry, electronic products have developed toward a trend of higher process speed and multi-function. Accordingly, the process speed of the logic processing component (such as CPU) and the memory in the computer system are also improving.

However, in addition to the process speed of the logic processing component and the memory which determine the operating efficiency in the computer system, the access speed of the storage device (such as hard drive) is also one of the significant factors. Since the storage device cannot improve access speed due to the irresoluble technological barrier, the access speed of the storage device can not keep up with the process speed of the CPU and memory, thus the overall efficiency of the computer system cannot be effectively improved.

In order to improve the access speed of the storage device in the computer system, a Redundant Array of Independent Disks (RAID) method has been introduced. The RAID assembles multiple sub storage devices into a single storage device. When data are accessed in the RAID storage device, the data are first divided into multiple portions, which are then stored in multiple sub storage devices simultaneously, thus achieving a faster access speed. In addition, in order to avoid errors during the data access operation, a parity check mechanism is applied in the RAID to recover the data where errors occur.

Since it is common for errors to occur in the data stored in the hard drive due to track damage or noise interruption, an encoding process is usually applied before the data are stored in the storage device. Therefore, erros can be recovered when occurring in the data stored in the storage device. In order to modify multiple errors in a series of data simultaneously, a multiplier with Galois Field GF (2^{m}) mathematic characteristic is commonly used in the computer system to encode and decode the data.

The Galois Field GF (2³) generated by a primitive polynomial of degree 3, such as 1+y+y³, is exemplified herein. If α is a root of this polynomial, the multiplication of theα⁴ andα⁵ in the Galois Field GF (2³) would be:
α⁴·α⁵=α⁴⁺⁵=α⁹=α⁷·α²=1·α²=α²
It is known from the above equation that the encoding process using the Galois Field GF (2^{m}) mathematic characteristic is very complicated. Therefore, the circuit of the multiplier is usually complex and the computation by CPU is time-consuming.

### SUMMARY OF THE INVENTION

Therefore, it is an object of the present invention to provide a Galois field multiplier that has a simplified operation circuit capable of reducing the complexity of logical circuit, and the GF multiplier could off-load CPU on the GF multiplication.

It is another object of the present invention to provide a multiplication method for the Galois field multiplier that has a simplified operation circuit capable of reducing the computing time.

A Galois field multiplier is provided in the present invention. The Galois field multiplier comprises a lookup table device and an operation circuit. Wherein, the lookup table device obtains a coefficient matrix W by looking up a multiplicator coefficient table based on a multiplicator S. The multiplicator S belongs to a Galois Field GF (2^{m}), S is represented as [sₘ₋₁ sₘ₋₂ . . . s₀], and W is represented as:

$$[ \begin{matrix}{w}_{m - 1 , m - 1} & {w}_{m - 1 , m - 2} & ⋯ & {w}_{m - 1 , 0} \\ {w}_{m - 2 , m - 1} & {w}_{m - 2 , m - 2} & ⋯ & {w}_{m - 2 , 0} \\ ⋮ & ⋮ & ⋮ & ⋮ \\ {w}_{0 , m - 1} & {w}_{0 , m - 2} & ⋯ & {w}_{0 , 0}\end{matrix} ]$$

where w_{i,j} in the matrix W is either 0 or 1.

The operation circuit is coupled to the lookup table device for receiving a multiplicand A and the coefficient matrix W to calculate a product of multiplication R. Both the multiplicand A and the product of multiplication R belong to a Galois Field GF (2^{m}). Wherein, A is represented as [aₘ₋₁ aₘ₋₂ . . . a₀], R is represented as [rₘ₋₁ rₘ₋₂ . . . r₀], and

$${r}_{m - 1} = {w}_{m - 1 , m - 1} {a}_{m - 1} + {w}_{m - 1 , m - 2} {a}_{m - 2} + ⋯ + {w}_{m - 1 , 0} {a}_{0}$$

$${r}_{m - 2} = {w}_{m - 2 , m - 1} {x}_{m - 1} + {w}_{m - 2 , m - 2} {x}_{m - 2} + ⋯ + {w}_{m - 2 , 0} {x}_{0}$$

$$⋮$$

$${r}_{0} = {w}_{0 , m - 1} {a}_{m - 1} + {w}_{0 , m - 2} {a}_{m - 2} + ⋯ + {w}_{0 , 0} {a}_{0}$$

The sign + shown in the equation represents a logical XOR operation, and wᵢaⱼ represents performing a logical AND operation on wᵢ and aⱼ.

In the Galois field multiplier according to an embodiment of the present invention, the operating circuit comprises a supplier circuit and an m amount of XOR gates. The supplier circuit is coupled to the lookup table device for receiving the multiplicand A and providing a matrix as shown below based on the coefficient matrix W:

$$[ \begin{matrix}{w}_{m , m} {a}_{m} & {w}_{m , m - 1} {a}_{m - 1} & ⋯ & {w}_{m , 0} {a}_{0} \\ {w}_{m - 1 , m} {a}_{m} & {w}_{m - , m - 1} {a}_{m - 1} & ⋯ & {w}_{m - 1 , 0} {a}_{0} \\ ⋮ & ⋮ & ⋮ & ⋮ \\ {w}_{0 , m} {a}_{m} & {w}_{0 , m - 1} {a}_{m - 1} & ⋯ & {w}_{0 , 0} {a}_{0}\end{matrix} ]$$

Wherein, wᵢaⱼ is used to determine whether to provide aⱼ based on the value of wᵢ. The m amount of XOR gates are coupled to the supplier circuit for providing a product of multiplication R based on the output of the circuit, and

$${r}_{m - 1} = {w}_{m - 1 , m - 1} {a}_{m - 1} + {w}_{m - 1 , m - 2} {a}_{m - 2} + ⋯ + {w}_{m - 1 , 0} {a}_{0}$$

$${r}_{m - 2} = {w}_{m - 2 , m - 1} {a}_{m - 1} + {w}_{m - 2 , m - 2} {a}_{m - 2} + ⋯ + {w}_{m - 2 , 0} {a}_{0}$$

$$⋮$$

$${r}_{0} = {w}_{0 , m - 1} {a}_{m - 1} + {w}_{0 , m - 2} {a}_{m - 2} + ⋯ + {w}_{0 , 0} {a}_{0}$$

The sign + shown in the equation represents a logical XOR operation.

In the Galois field multiplier according to an embodiment of the present invention, the supplier circuit comprises an m²amount of logical AND gates.

In the Galois field multiplier according to an embodiment of the present invention, the lookup table device comprises a memory for storing the multiplicator coefficient table.

In the Galois field multiplier according to an embodiment of the present invention, the lookup table device comprises a computer system and a set of registers. The computer system executes a plurality of instructions and outputs a coefficient matrix W. The registers are used to temporarily store the coefficient matrix W.

The present invention further provides a multiplication method applied in the Galois field. The multiplication method comprises the following steps. First, a multiplicand A and a multiplicator S are input in the multiplier, and both the multiplicand A and the multiplicator S belong to a Galois Field GF (2^{m}). Wherein, A is represented as [aₘ₋₁ aₘ₋₂ . . . a₀], and S is represented as [sₘ₋₁ sₘ₋₂ . . . s₀]. Then, a coefficient matrix W is obtained by looking up a multiplicator coefficient matrix based on the multiplicator S, wherein W is represented as:

$$[ \begin{matrix}{w}_{m - 1 , m - 1} & {w}_{m - 1 , m - 2} & ⋯ & {w}_{m - 1 , 0} \\ {w}_{m - 2 , m - 1} & {w}_{m - 2 , m - 2} & ⋯ & {w}_{m - 2 , 0} \\ ⋮ & ⋮ & ⋮ & ⋮ \\ {w}_{0 , m - 1} & {w}_{0 , m - 2} & ⋯ & {w}_{0 , 0}\end{matrix} ]$$

Then, a product of multiplication R is obtained from multiplying the coefficient matrix W by the multiplicand A, and the product of multiplication R belongs to the Galois Field GF (₂^{m}), wherein R is represented as [rₘ₋₁ rₘ₋₂ . . . r₀], and

$${r}_{m - 1} = {w}_{m - 1 , m - 1} {a}_{m - 1} + {w}_{m - 1 , m - 2} {a}_{m - 2} + ⋯ + {w}_{m - 1 , 0} {a}_{0}$$

$${r}_{m - 2} = {w}_{m - 2 , m - 1} {x}_{m - 1} + {w}_{m - 2 , m - 2} {x}_{m - 2} + ⋯ + {w}_{m - 2 , 0} {x}_{0}$$

$$⋮$$

$${r}_{0} = {w}_{0 , m - 1} {a}_{m - 1} + {w}_{0 , m - 2} {a}_{m - 2} + ⋯ + {w}_{0 , 0} {a}_{0}$$

The sign + shown in the equation represents a logical XOR operation, and wᵢaⱼ represents performing a logical AND operation on wᵢ and aⱼ.

In the multiplication method applied in the Galois field according to an embodiment of the present invention, the step of performing the logic operation on wᵢ and aⱼ is used to determine whether to provide aⱼ for further operation based on the value of wᵢ.

The multiplication method applied in the Galois field according to an embodiment of the present invention further comprises forming a Galois Field GF (2^{m}) with an primitive polynomial of degree m, and obtaining an output T from multiplying an input X by the multiplicator S in the Galois Field GF (2^{m}), wherein X is represented as [xₘ₋₁ xₘ₋₂ . . . x₀], T is represented as [tₘ₋₁ tₘ₋₂ . . . t₀], and

$${t}_{m - 1} = {w}_{m - 1 , m - 1} {x}_{m - 1} + {w}_{m - 1 , m - 2} {x}_{m - 2} + ⋯ + {w}_{m - 1 , 0} {x}_{0}$$

$${t}_{m - 2} = {w}_{m - 2 , m - 1} {x}_{m - 1} + {w}_{m - 2 , m - 2} {x}_{m - 2} + ⋯ + {w}_{m - 2 , 0} {x}_{0}$$

$$⋮$$

$${t}_{0} = {w}_{0 , m - 1} {x}_{m - 1} + {w}_{0 , m - 2} {x}_{m - 2} + ⋯ + {w}_{0 , 0} {x}_{0}$$

The sign + shown in the equation represents a logical XOR operation, and wᵢxⱼ represents performing a logical AND operation on wᵢ and xⱼ. Therefore, the output T represents the product of the multiplication of the coefficient matrix W by the input X.

Finally, a 2^{m}-1 amount of possible coefficient matrix W are obtained and stored, and a multiplicator coefficient table is obtained.

In the present invention, a coefficient matrix W is obtained by looking up a lookup table device having a multiplicator coefficient table based on a multiplicator S. Then, the coefficient matrix W and a multiplicand A are received through a supplier circuit coupled to the lookup table device, and it is determined whether to provide the multiplicand A to the XOR gates based on the coefficient matrix W. Finally, a product of multiplication R is obtained from the operation of the m amount of XOR gates. Therefore, when multiplication operation is performed in the Galois Field GF (2^{m}), the present invention is capable of simplifying the operation circuit and reducing the computing time by looking up the lookup table.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a block diagram of a Galois field multiplier according to an embodiment of the present invention.

FIGS. 2 and 3 schematically show diagrams of a lookup table device in the Galois field multiplier according to an embodiment of the present invention.

### DESCRIPTION OF THE EMBODIMENTS

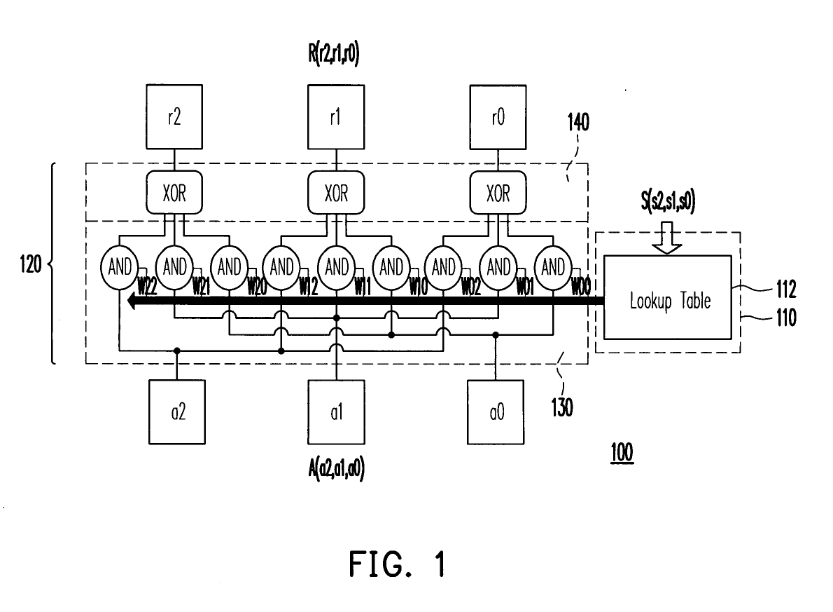

FIG. 1 schematically shows a block diagram of a Galois field multiplier according to an embodiment of the present invention. Referring to FIG. 1, a Galois field multiplier 100 of the present embodiment is generated in a Galois field GF (2³) formed by a primitive polynomial of degree 3 (such as 1+y+y³). The Galois field multiplier comprises a lookup table device 110 and an operation circuit 120. Wherein, the lookup table device 110 obtains a coefficient matrix W by looking up a multiplicator coefficient table 112 based on a multiplicator S. The multiplicator S belongs to a Galois field (2³), and is represented as [s₂ s₁ s₀], and W is represented as:

$$[ \begin{matrix}{w}_{2 , 2} & {w}_{2 , 1} & {w}_{2 , 0} \\ {w}_{1 , 2} & {w}_{1 , 1} & {w}_{1 , 0} \\ {w}_{0 , 2} & {w}_{0 , 1} & {w}_{0 , 0}\end{matrix} ]$$

where w_{i,j} in the matrix W is either 0 or 1.

In addition, the operation circuit 120 is coupled to the lookup table device 110 for receiving a multiplicand A and the coefficient matrix W outputted from the lookup table device 110 to calculate a product of multiplication R. Wherein, both the multiplicand A and the product of multiplication R belong to a Galois field (2³). A is represented as [a₂ a₁ a₀], and R is represented as [r₂ r₁ r₀]. The operation circuit 120 further comprises a supplier circuit 130 and an m amount of XOR gates 140. Wherein, the supplier circuit 130 (such as m² amount of AND gates) is coupled to the lookup table device 110, and the XOR gates 140 are coupled to the supplier circuit 130.

Referring to FIG. 1, after the Galois field multiplier 100 has received a multiplicand A, the lookup table device 110 obtains a coefficient matrix W by looking up the multiplicator coefficient table 112 based on the multiplicator S. Then, the supplier circuit 130 receives the coefficient matrix W and the multiplicand A from the lookup device 110, and provides a matrix as shown below based on the coefficient matrix W:

$$[ \begin{matrix}{w}_{2 , 2} {a}_{2} & {w}_{2 , 1} {a}_{1} & {w}_{2 , 0} {a}_{0} \\ {w}_{1 , 2} {a}_{2} & {w}_{1 , 1} {a}_{1} & {w}_{1 , 0} {a}_{0} \\ {w}_{0 , 2} {a}_{2} & {w}_{0 , 1} {a}_{1} & {w}_{0 , 0} {a}_{0}\end{matrix} ]$$

Wherein, wᵢaⱼ is used to determine whether to provide aⱼ to XOR gates 140 based on wᵢ. The XOR gates 140 calculates the product of multiplication R based on the output of the supplier circuit 130, wherein
r₂=w_{2,2}a₂+w_{2,1}a₁+w_{2,0}a₀
r₁=w_{1,2}a₂+w_{1,1}a₁+w_{1,0}a₀
r₀=w_{0,2}a₂+w_{0,1}a₁+w_{0,0}a₀
The sign + shown in the equation represents a logical XOR operation, and wᵢaⱼ represents performing a logical AND operation on wᵢ and aⱼ.

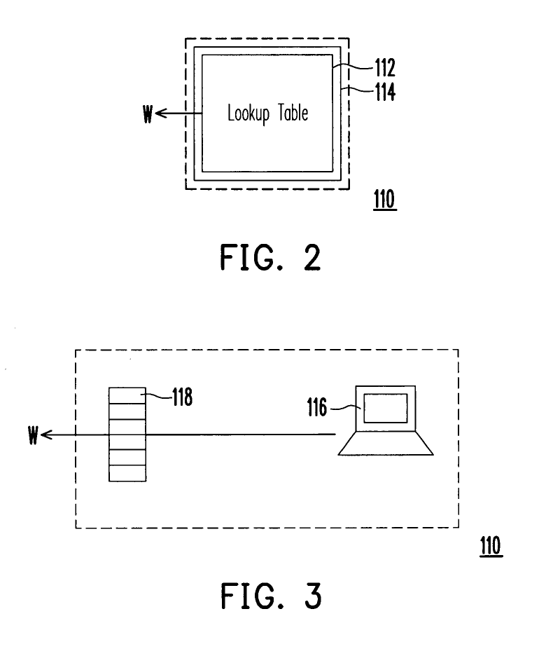

FIGS. 2 and 3 schematically show diagrams of a lookup table device in the Galois field multiplier according to an embodiment of the present invention. Referring to FIGS. 1-3, the lookup table device 110 may comprise a memory 114 for storing the multiplicator coefficient table 112. Therefore, the lookup table device 110 outputs a coefficient matrix W from the memory 114 based on the multiplicator S. In addition, the lookup table device 110 may further comprise a computer system 116 and a set of registers 118. Therefore, the computer system 116 generates a coefficient matrix W and temporarily stores it in the registers 118 after executing a series of instructions based on the multiplicator S.

Referring to FIG. 1 again, the step of generating the multiplicator coefficient table 112 comprises forming a Galois field (2³) with a primitive polynomial of degree 3(such as 1+y+y³), multiplying an input X by the multiplicator S, and finally obtaining an output T. Wherein, X is represented as [x₂ x₁ x₀], T is represented as [t₂ t₁ t₀], and
t₂=w_{2,2}x₂+w_{2,1}x₁+w_{2,0}x₀
t₁=W_{1,2}x₂+w_{1,1}x₁+w_{1,0}x₀
t₀=w_{0,2}x₂+w_{0,1}x₁+w_{0,0}x₀
The sign + shown in the equation represents a logical XOR operation, and wᵢxⱼ represents performing a logical AND operation on wᵢ and xⱼ. Then, the output T represents a product of multiplication of the coefficient matrix W by the input X; i.e. T=WX. For example, if the input X is [x₂ x₁ x₀], and the multiplicator S is α², when the Galois Field GF (2³) multiplication operation is performed by the input X and the multiplicator S, the input X is represented as:
x₂α²+x₁α+x₀, and
X*α²=(x₂α²+x₁α+x₀)*α²=x₂α⁴+x₁α³+x₀α²
and since any non-zero elementα^{k} in Galois Field GF (2^{m}) could be expressed as some combination of {α^{m-1}, α^{m-2}, . . . α¹, 1}:
α^{k}=Sₘ₋₁α^{m-1}+Sₘ₋₂α^{m-2}+ . . . +S₁α¹+S₀, where Sᵢ is either 1 or 0.
In this example, GF (2³) which is generated by the primitive polynomial 1+y+y³, So

$${α}^{3} = α + 1 , {α}^{4} = {α}^{2} + α$$

$$\begin{matrix}X * {α}^{2} = {x}_{2} ( {α}^{2} + α ) + {x}_{1} ( α + 1 ) + {x}_{0} {α}^{2} \\ = ( {x}_{2} + {x}_{0} ) {α}^{2} + ( {x}_{2} + {x}_{1} ) α + {x}_{1}\end{matrix}$$

It is known from above that

$$\begin{matrix}{X}^{*} {α}^{2} = [ \begin{matrix}{x}_{2} + {x}_{0} \\ {x}_{2} + {x}_{1} \\ {x}_{1}\end{matrix} ] = [ \begin{matrix}1 & 0 & 1 \\ 1 & 1 & 0 \\ 0 & 1 & 0\end{matrix} ] [ \begin{matrix}{x}_{2} \\ {x}_{1} \\ {x}_{0}\end{matrix} ] \\ = WX = T \\ \end{matrix}$$

The sign + shown in the equation represents a logical XOR operation, and * indicates performing a Galois field (2³) multiplication operation. Based on the above equations, the multiplicator coefficient table 112 is obtained by calculating and storing 2^{m}-1 amount of possible coefficient matrix W.

Based on the above descriptions, it will be apparent to one of the ordinary skill in the art that the present invention is not limited to the description of the present embodiment, generating a Galois field (2³) by using a primitive polynomial of degree 3, and generating a Galois field multiplier based on the Galois field (2³). In addition, it is also possible to calculate a method of forming a Galois field (2^{m}) with a primitive polynomial of degree m, and generates a Galois field multiplier based on the Galois field (2^{m}) according to the present invention.

In summary, in the present invention, a coefficient matrix W is obtained by looking up a lookup table device having a multiplicator coefficient table based on a multiplicator S. Then, a multiplicand is received through a supplier circuit coupled to the lookup table device, and it is determined whether to provide the multiplicand to the XOR gates based on the coefficient matrix W. Finally, a product of multiplication R is obtained from the operation of m amount of XOR gates. Therefore, when the multiplication operation is performed in the Galois field, the present invention is capable of simplifying the operation circuit and reducing the computing time by looking up the lookup table.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A Galois field multiplier, comprising:
a lookup table device for obtaining a coefficient matrix W by looking up a multiplicator coefficient table based on a multiplicator S, wherein the multiplicator S belongs to a Galois field, S is represented as [sₘ₋₁ sₘ₋₂ . . . s₀], and W is represented as:
$$[ \begin{matrix}{w}_{m - 1 , m - 1} & {w}_{m - 1 , m - 2} & ⋯ & {w}_{m - 1 , 0} \\ {w}_{m - 2 , m - 1} & {w}_{m - 2 , m - 2} & ⋯ & {w}_{m - 2 , 0} \\ ⋮ & ⋮ & ⋮ & ⋮ \\ {w}_{0 , m - 1} & {w}_{0 , m - 2} & ⋯ & {w}_{0 , 0}\end{matrix} ] ; and$$
an operation circuit coupled to the lookup table device for receiving a multiplicand A and the coefficient matrix W to obtain a product of multiplication R, and both the multiplicand A and the product of multiplication R belong to the Galois field, wherein A is represented as [aₘ₋₁ aₘ₋₂ . . . a₀], R is represented as [rₘ₋₁ rₘ₋₂ . . . r₀], and
$$\begin{matrix}{r}_{m - 1} = {w}_{m - 1 , m - 1} {a}_{m - 1} + {w}_{m - 1 , m - 2} {a}_{m - 2} + … + {w}_{m - 1 , 0} {a}_{0} \\ {r}_{m - 2} = {w}_{m - 2 , m - 1} {a}_{m - 1} + {w}_{m - 2 , m - 2} {a}_{m - 2} + … + {w}_{m - 2 , 0} {a}_{0} \\ ⋮ \\ {r}_{0} = {w}_{0 , m - 1} {a}_{m - 1} + {w}_{0 , m - 2} {a}_{m - 2} + … + {w}_{0 , 0} {a}_{0}\end{matrix}$$
wherein the sign + shown in the equation represents a logical XOR operation, and wᵢaⱼ represents performing a logical AND operation on wᵢ and aⱼ.

2. The Galois field multiplier of claim 1, wherein the operation circuit comprises:
a supplier circuit coupled to the lookup table device for receiving the multiplicand A to output the following equation based on the coefficient matrix W:
$$[ \begin{matrix}{w}_{m - 1 , m - 1} {a}_{m - 1} & {w}_{m - 1 , m - 2} {a}_{m - 2} & ⋯ & {w}_{m - 1 , 0} {a}_{0} \\ {w}_{m - 2 , m - 1} {a}_{m - 1} & {w}_{m - 2 , m - 2} {a}_{m - 2} & ⋯ & {w}_{m - 2 , 0} {a}_{0} \\ ⋮ & ⋮ & ⋮ & ⋮ \\ {w}_{0 , m - 1} {a}_{m - 1} & {w}_{0 , m - 2} {a}_{m - 2} & ⋯ & {w}_{0 , 0} {a}_{0}\end{matrix} ]$$
wherein wᵢaⱼ is used to determine whether to provide aⱼ based on wᵢ; and
m amount of XOR gates coupled to the supplier circuit for providing the product of multiplication R based on the output of the supplier circuit, and
$$\begin{matrix}{r}_{m - 1} = {w}_{m - 1 , m - 1} {a}_{m - 1} + {w}_{m - 1 , m - 2} {a}_{m - 1} + … + {w}_{m - 1 , 0} {a}_{0} \\ {r}_{m - 2} = {w}_{m - 2 , m - 1} {x}_{m - 1} + {w}_{m - 2 , m - 2} {x}_{m - 2} + … + {w}_{m - 2 , 0} {x}_{0} \\ ⋮ \\ {r}_{0} = {w}_{0 , m - 1} {a}_{m - 1} + {w}_{0 , m - 2} {a}_{m - 2} + … + {w}_{0 , 0} {a}_{0}\end{matrix}$$
wherein the sign + shown in the equation represents a logical XOR operation.

3. The Galois field multiplier of claim 2, wherein the supplier circuit comprises an m² amount of AND gates.

4. The Galois field multiplier of claim 1, wherein the lookup table device comprises a memory for storing the multiplicator coefficient table.

5. The Galois field multiplier of claim 1, wherein the lookup table device comprises:
a computer system for executing a plurality of instructions and providing the coefficient matrix W; and
a set of registers for temporarily storing the coefficient matrix W.

6. A multiplication method applied in a Galois field, the multiplication method comprising:
inputting a multiplicand A and a multiplicator S, both the multiplicand A and the multiplicator S belonging to a Galois field, wherein A being represented as [aₘ₋₁ aₘ₋₂ . . . a₀], and S being represented as [sₘ₋₁ sₘ₋₂ . . . s₀];
using the multiplicator S to obtain a coefficient matrix W by looking up a multiplicator coefficient table, wherein W is represented as
$$[ \begin{matrix}{w}_{m - 1 , m - 1} & {w}_{m - 1 , m - 2} & ⋯ & {w}_{m - 1 , 0} \\ {w}_{m - 2 , m - 1} & {w}_{m - 2 , m - 2} & ⋯ & {w}_{m - 2 , 0} \\ ⋮ & ⋮ & ⋮ & ⋮ \\ {w}_{0 , m - 1} & {w}_{0 , m - 2} & ⋯ & {w}_{0 , 0}\end{matrix} ] ; and$$
obtaining a product of multiplication R of the coefficient matrix W by the multiplicand A, and the product of multiplication R belonging to the Galois field, wherein R is represented as [rₘ₋₁ rₘ₋₂ . . . r₀], and
$$\begin{matrix}{r}_{m - 1} = {w}_{m - 1 , m - 1} {a}_{m - 1} + {w}_{m - 1 , m - 2} {a}_{m - 2} + … + {w}_{m - 1 , 0} {a}_{0} \\ {r}_{m - 2} = {w}_{m - 2 , m - 1} {x}_{m - 1} + {w}_{m - 2 , m - 2} {x}_{m - 2} + … + {w}_{m - 2 , 0} {x}_{0} \\ ⋮ \\ {r}_{0} = {w}_{0 , m - 1} {a}_{m - 1} + {w}_{0 , m - 2} {a}_{m - 2} + … + {w}_{0 , 0} {a}_{0}\end{matrix}$$
wherein the sign + shown in the equation represents a logical XOR operation, and wᵢaⱼ represents performing a logical AND operation on wᵢ and aⱼ.

7. The multiplication method applied in a Galois field of claim 6, wherein the step of performing the logic operation on wᵢ and aⱼ is to determine whether to provide aⱼ for further operation based on wᵢ.

8. The multiplication method applied in a Galois field of claim 6, further comprising forming a Galois field (2^{m}) with an m order primitive polynomial, and obtaining an output T by multiplying an input X by the multiplicator S in the Galois field (2^{m}), wherein X is represented as [xₘ₋₁ xₘ₋₂ . . . x₀], T is represented as [tₘ₋₁ tₘ₋₂ . . . t₀], and
$$\begin{matrix}{t}_{m - 1} = {w}_{m - 1 , m - 1} {x}_{m - 1} + {w}_{m - 1 , m - 2} {x}_{m - 2} + … + {w}_{m - 1 , 0} {x}_{0} \\ {t}_{m - 2} = {w}_{m - 2 , m - 1} {x}_{m - 1} + {w}_{m - 2 , m - 2} {x}_{m - 2} + … + {w}_{m - 2 , 0} {x}_{0} \\ ⋮ \\ {t}_{0} = {w}_{0 , m - 1} {x}_{m - 1} + {w}_{0 , m - 2} {x}_{m - 2} + … + {w}_{0 , 0} {x}_{0}\end{matrix}$$
wherein the sign + shown in the equation represents a logical XOR operation, and wᵢxⱼ represents performing a logical AND operation on wᵢ and xⱼ, therefore the output T represents the product of the multiplication of the coefficient matrix W by the input X; and
obtaining a multiplicator coefficient table by calculating and storing 2m-1 amount of possible coefficient matrix W.
